(19) United States
(12) Patent Application Publication
(10) Pub. No.: US 2020/0362811 A1
(43) Pub. Date: Nov. 19, 2020

(54) HYDRAULIC MACHINE COMPRISING A RADIAL FLOW RUNNER

(71) Applicant: VOITH PATENT GMBH, HEIDENHEIM (DE)

(72) Inventors: STUART COULSON, SEVEN VALLEYS (PA); BRANDON HARMER, YORK, PA (US); JESSE ZOLL, MOUNTVILLE, PA (US)

(21) Appl. No.: 16/636,839

(22) PCT Filed: Aug. 9, 2018
(86) PCT No.: PCT/EP2018/071616

§ 371 Date: Feb. 5, 2020

Related U.S. Application Data
(60) Provisional application No. 62/545,135, filed on Aug. 14, 2017.
(60) Provisional application No. 62/713,650, filed on Aug. 2, 2018.

(51) Int. Cl. F03B 3/02; F03B 11/00

(52) U.S. Cl. CPC F03B 3/02; F03B 11/006

(57) ABSTRACT

A hydraulic machine has a runner of the Francis type, a head cover and a lower cover. A crown has a seal that seals the space between the crown and the head cover against water from the high pressure side. The runner is formed with at least one passage that is capable to drain high pressure leakage water passing the seal to the low pressure side. The passage is formed with an inlet aperture located in a portion of the crown which during operation is exposed to high pressure leakage water. The passage is located within one of the blades and leads from the inlet aperture to the band, where the passage forms an opening leading to the space between the band and the lower cover. The head cover is formed with an air inlet to admit air to the chamber between the head cover and the crown.

The present invention relates generally to hydroelectric turbine or pump installations comprising a radial flow runner of the Francis type.

The objective of the present invention is to improve the known hydraulic machine concerning efficiency, vibration and noise behavior in the partial load regime.

It is known, that by adding air to the water flowing through the runner of the radial flow type, the efficiency in the partial load regime can be materially enhanced (see e.g. U.S. Pat. No. 1,823,624 to Nagler). In practice, it turns out that for adding air a compressor is needed. The compressor consumes power and partially or completely negates the benefit of reducing friction losses. The objective of the present invention is to disclose a layout of a hydraulic machine where no compressor or at least a compressor consuming less power compared to the state of the art is needed for air admission.

This objective is achieved by a hydraulic machine according to claim 1. Other favorable implementations of the invention are disclosed in the depended claims.

The inventors have recognized that this objective can be achieved by a runner comprising at least one passage leading from the runner crown to the runner band whereas the passage is located within one of the runner blades and an air admission opening positioned in the head cover above the runner.

The invention will hereinafter be described in conjunction with the appended drawings:

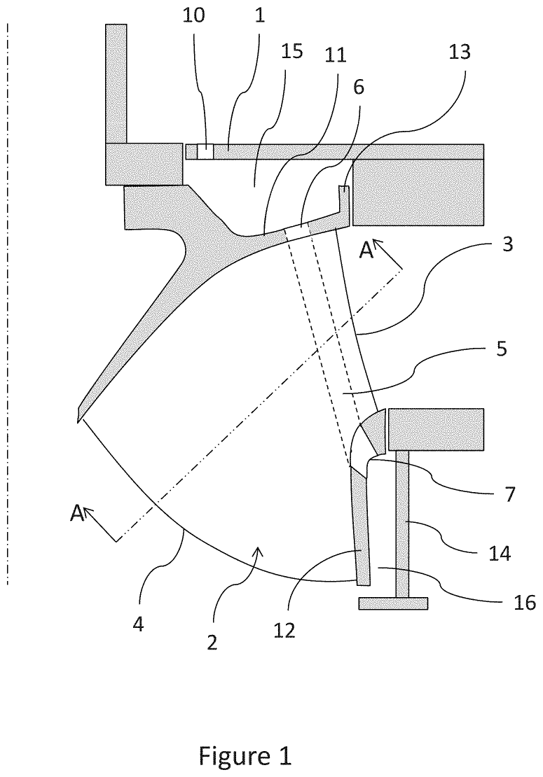

FIG. 1 is a cross-sectional view of a portion of a Francis turbine according to the present invention;

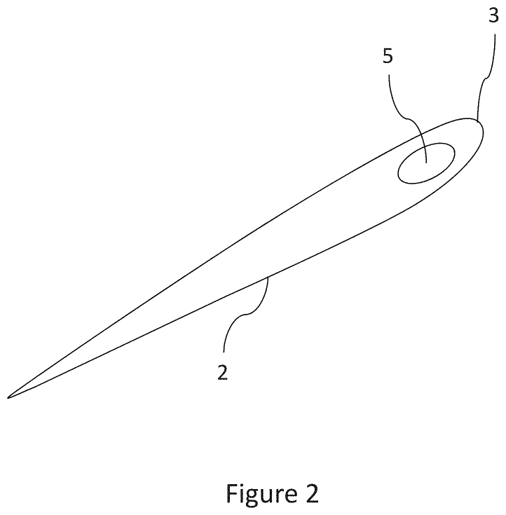

FIG. 2 shows section A according to a first embodiment of a runner blade according to FIG. 1;

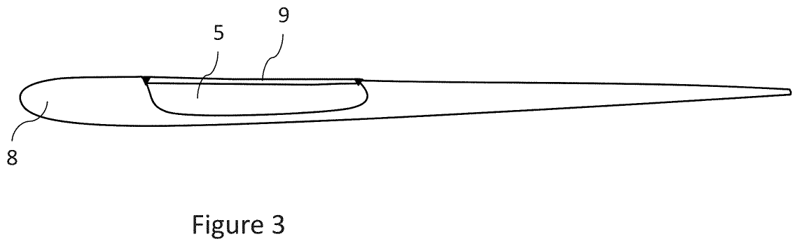

FIG. 3 shows section A according to another embodiment of a runner blade according to FIG. 1.

FIG. 1 displays schematically a cross-sectional view of a hydraulic machine comprising a Francis type runner according to the present invention. The head cover is designated as 1 and the lower cover as 14. The head cover 1 comprises an air inlet, which is designated by 10. The runner comprises a runner crown, which is designated as 11. Between the head cover 1 and the runner crown 11 a chamber is located, which is designated by 15. The air inlet 10 connects the chamber 15 above the runner crown 11 to the area above the head cover 1, which is exposed to atmospheric air.

A runner blade 2 extends between the crown 11 and the band designated as 12. The blade 2 has two edges designated by 3 and 4. The fluid entering the runner flows from edge 3 towards edge 4, whereas the high pressure side adjoins to edge 3 and the low pressure side adjoins to edge 4. It is clear that in pumping mode the flow direction of the fluid is reversed. The runner crown 11 comprises circumferential located sealing means designated as 13. Sealing means 13 are construed to seal the space between head cover 1 and crown 11 against high pressure water. However due to the imperfection of the sealing a amount of high pressure water will be present in the space above the runner crown 11. The runner crown 11 comprises an inlet aperture designated by 6. The inlet aperture 6 is located in a portion of the crown, which is exposed to high pressure water passing the sealing means 13. The blade 2 comprises a passage designated by 5. The passage 5 leads from inlet aperture 6 to the band 12 where the passage 5 forms an opening which is designated by 7. The high pressure in the chamber 15 above the runner crown 11 leads to draining the leakage water from the space above crown 11 directly through the passage 5 inside blade 2 and the opening 7 to a chamber which is located between the band 12 and the lower cover 14, which is designated by 16. This chamber 16 is connected to the low pressure side of the runner. The dash-dotted line on the left side of FIG. 1 indicates the axis of rotation of the runner.

Since opening 7 is ideally located at an equal or even slightly larger radial distance from the axis of rotation than the inlet aperture 6 backpressure is avoided due to the radial pumping effect of rotation.

For a similar reason the pressure distribution within the chamber 15 above the runner crown 11 is not uniform. The pressure is highest at the region of the highest distance and is lowest at the region of the smallest distance from the axis of rotation. Therefore, it is favorable, that the air inlet 10 is positioned in the head cover 1 at the smallest distance possible from the axis of rotation but outside the flange of the shaft that connects to the runner crown 11. At least the air inlet 10 is located at a diameter smaller than the locating diameter of the inlet aperture 6.

During operation of the hydraulic machine, air is sucked in through the air inlet 10 into the chamber 15 above the runner crown 11 or has to be pumped in by a compressor with little effort. This air partially fills the chamber 15 above the runner crown 11 forming an air cushion. From there air is transported by the water flow through the at least one passage 5 to the chamber 16 between band 12 and lower cover 14 forming an air cushion. Thus, air surrounds the periphery of the runner before flowing out into the water in the main flow passage exiting the hydraulic machine. As a result, friction losses, vibration and noise are reduced increasing the efficiency of the hydraulic machine.

By admitting the air at into the chamber 15 above the runner crown 11 above the rotating runner it will naturally accumulate, disperse and fill the chamber 15 until it reaches the passage 5 through the runner blade 2 where it will flow into the peripheral chamber 16. It enters the peripheral chamber 16 through the passage 5 in the rotation runner blade in an area where the flow velocity in the chamber is mainly in the peripheral direction, so it can also accumulate and provide good coverage of the outer surface of the rotating runner without necessitating a large mass-flow of air. Since the outer wall of the peripheral chamber 16 is at higher pressure, the air will be more concentrated close to the runner periphery where it is most beneficial for drag reduction.

Since many modernization projects of hydraulic machines involve the replacement of the turbine runner, the invention also has the advantage that it can be easily retrofitted to existing machines. The new runner would be provided with hollow blade passages according to the invention and the air inlet could easily be added to the head cover above the runner.

To further facilitate the airflow, the following modifications of the present invention may be applied (alone or in combination):
Increased number of air inlets 10.
Increased number of passages 5, meaning that more than one blade 2 incorporates a passage 5 whereas in extreme each blade 2 can comprise a passage 5.
In order to reduce pressure at the exit of the passage 5, a flow deflector may be positioned just upstream of the opening 7 on the outer surface of the band (12).
In order to reduce pressure at the exit of the passage 5, the downstream edge of the opening 7 within the band could be profiled.

FIG. 2 displays schematically a cross-sectional view through the blade 2 of FIG. 1 along the marked section A. The passage 5 is located near edge 3 adjoining the high pressure side of blade 2. This part of the blade 2 is typically relatively thick and straight. Normally the blade 2 is machined from a casting. The passage 5 according to the embodiment of FIG. 2 is formed directly while casting the blade 2 which is thus of single piece construction.

FIG. 3 displays schematically a cross-sectional view through the blade 2 of FIG. 1 along the marked section A according to another embodiment of the present invention. In the view along section A it can be seen that the blade 2 comprises a base part which is designated by 8 and a cover part which is designated by 9. The base part 8 includes either the entire suction side or pressure side surface of the blade, as well as the entire surface of the edge adjoining the high pressure side and the entire surface of the edge adjoining the low pressure side. A cavity is machined or cast into the base part 8. The thinner cover part 9 is attached to the base part 8 thus forming the passage 5. The cover part 9 may be metal or composite material, may be cast formed or machined and may be attached by welding or by a bonding material (epoxy, glue, etc.).

The blade could also be produced with a cavity directly by rapid prototyping methods such as additive manufacturing.

1-10. (canceled)

11. A hydraulic machine, comprising:
a runner of Francis type having a head cover, a lower cover, a low pressure side and a high pressure side, a crown, a band, a chamber formed between said head cover and said crown, and a chamber formed between said lower cover and said band;
said runner having a plurality of blades each being defined by a pressure surface, an oppositely facing suction surface, an edge adjoining said high pressure side and a spaced-apart edge adjoining said low pressure side of said runner;
said crown including a seal disposed to seal said chamber between said crown and said head cover against water from said high pressure side;
said head cover having an air inlet formed therein connecting an area above said head cover with said chamber between said head cover and said crown;
said runner being formed with at least one passage within one of said blades and configured to drain high pressure leakage water passing said seal to said low pressure side, said at least one passage having an inlet aperture located in a portion of said crown which, during operation, is exposed to high pressure leakage water;
said passage leading from said inlet aperture to said band, where said passage forms an opening leading to said chamber between said band and said lower cover, and which chamber is in communication with said low pressure side of the runner.

12. The hydraulic machine according to claim 11, wherein said air inlet within said head cover is located at a diameter smaller than a locating diameter of said inlet aperture.

13. The hydraulic machine according to claim 11, wherein said blade that is formed with said passage is of single piece construction and is machined from a casting including said passage.

14. The hydraulic machine according to claim 11, wherein said blade that is formed with said passage comprises a base part and a cover part, said base part is of single piece construction including an entire edge adjoining said high pressure side, an entire pressure side of said blade, and an entire surface of an edge adjoining said low pressure side, and wherein said base part is formed with a cavity and said cover part is attached to said base part above said cavity to form said passage.

15. The hydraulic machine according to claim 11, wherein said blade that is formed with said passage comprises a base part and a cover part, said base part is of single piece construction including an entire edge adjoining said high pressure side, an entire suction side of said blade, and an entire surface of an edge adjoining said low pressure side, and wherein said base part is formed with a cavity and said cover part is attached to said base part above said cavity to form said passage.

16. The hydraulic machine according to claim 11, wherein said blade that is formed with said passage is of single piece construction and has the characteristics of having been produced by a rapid prototyping method.

17. The hydraulic machine according to claim 16, wherein said blade that is formed with said passage has the characteristics of having been formed by additive manufacturing.

18. The hydraulic machine according to claim 11, wherein each of said plurality of blades is formed with a respective said passage.

19. The hydraulic machine according to claim 11, wherein said opening of said passage is formed at an equal or greater radial distance from an axis of rotation of said runner than said inlet aperture.

20. The hydraulic machine according to claim 11, further comprising a flow deflector disposed upstream of said opening of said passage on an outer surface of said band.
